(19) United States
(12) Patent Application Publication
(10) Pub. No.: US 2025/0125506 A1
(43) Pub. Date: Apr. 17, 2025

(54) CONNECTOR

(71) Applicant: Taicang Manaflex Technology Co., Ltd., Taicang City (CN)

(72) Inventors: Robert C. Lane, Las Vegas, NV (US); Yifei Liu, Toronto (CA); Augusto E. Barton, Pinecrest, FL (US)

(21) Appl. No.: 18/810,710

(22) Filed: Aug. 21, 2024

(30) Foreign Application Priority Data
Aug. 22, 2023 (CN) 202322256924.5

(51) Int. Cl. H01M 50/583; H01B 5/00; H01H 85/02; H01M 50/503; H01M 50/519; H01M 50/522; H01M 50/569

(52) U.S. Cl. CPC H01M 50/583; H01B 5/002; H01M 50/503; H01M 50/519; H01M 50/522; H01M 50/569; H01H 85/0241; H01M 2200/103

(57) ABSTRACT

A bus bar includes a bus plate for integrating battery cores and an electrically connected VSH component of the bus plate. The bus board has several connections connected to the positive or negative electrodes of the battery cells. Rows and insulation layers cover both sides of the connection rows. The VSH assembly includes a first circuit board that includes connecting lines and insulating films covering both sides of the connecting lines. One end of the battery core is connected to the corresponding connection line through a fuse, and the fuse is arranged on the corresponding insulation. On the outside of the film and the insulating layer, several welding windows are provided in the insulating film and the insulating layer. The connection lines and connection rows form soldering pads at corresponding soldering windows.

### CROSS-REFERENCE TO RELATED APPLICATION

This application claims priority to and the benefit of Chinese Utility Model application No. 202322256924.5, filed Aug. 22, 2023, the entire disclosure of which is incorporated by reference in its entirety.

### TECHNICAL FIELD

This disclosure relates to the technical field of new energy batteries, and in particular to a busbar.

### BACKGROUND TECHNOLOGY

Generally, a battery module includes a shell and a plurality of cells/columnar batteries arranged in the shell. The cells/columnar batteries are connected as a whole through a busbar, and the busbar is connected to a battery management system (“BMS”) through a circuit board or the like. In actual production, in order to improve the safety of use, it is necessary to set a fuse to avoid accidents such as line damage or fire caused by excessive current; among them, the fuse is mostly processed directly on the product body, and the thickness of the material used in the product body affects the cross-sectional area of the fuse: under the requirements of cross-sectional area and length, the lower the requirement of the fuse current, the smaller the width of the fuse, and the greater the difficulty of the corresponding production process; and to meet the requirements of cross-sectional area and width (processing limit), the lower the requirement of the fuse current, the longer the corresponding length of the fuse, and sufficient accommodation space is required, or the fuse is designed to be curved, but during the power-on process, the fuse is easily curled and deformed due to heat, etc., and the curled and deformed fuse is easy to short-circuit and lose the original fuse characteristics. Therefore, it is necessary to propose improvements.

### SUMMARY

The purpose of the techniques disclosed herein is to provide a busbar to overcome the deficiencies in the prior art.

To achieve the above-mentioned purpose, the techniques disclosed herein provide the following technical solutions: The aspects of this disclosure include a busbar, including a busbar for integrating battery cells and a voltage sense harness (“VSH”) component electrically connected to the busbar, wherein the busbar is provided with a plurality of connection bars connected to the positive or negative electrodes of the battery cells and an insulating layer covering both sides of the connection bars, wherein the VSH component includes a first circuit board, wherein the first circuit board includes a plurality of connection lines and an insulating film covering both sides of the connection lines, wherein one end of the connection line away from the battery cell is connected to the corresponding connection line through a fuse, wherein the fuse is provided on the outside of the corresponding insulating film and insulating layer, wherein the insulating film and insulating layer are respectively provided with a plurality of welding windows, wherein the connection lines and the connection bars are respectively formed with welding pads at the corresponding welding windows, and wherein both ends of the fuse are respectively electrically connected to the corresponding welding pads.

Further, in the above-mentioned busbar, a mica sheet is provided between the fuse and the insulating film and the insulating layer, and an avoidance groove corresponding to the welding window is provided in the mica sheet.

Further, in the above-mentioned busbar, welding terminals are respectively protruded at both ends of the fuse, and the welding terminals are integrally formed with the fuse.

Further, in the above-mentioned busbar, the insulating layer and the insulating film on the same side are an integrated structure.

Further, in the above-mentioned busbar, the connecting line, the connecting bar and the fuse are made of the same conductive material.

Further, in the above-mentioned busbar, the connecting line, the connecting bar and the fuse are all made of metal aluminum.

Further, in the above-mentioned busbar, the connecting line, the connecting bar and the fuse are all made of metal copper.

Further, in the above-mentioned busbar, the connection line, the connection bar and the fuse are made of different conductive materials, and a transfer layer is provided on the end face of the soldering pad close to the fuse or the side face of the fuse end close to the soldering pad.

Further, in the above-mentioned busbar, the connection line and the connection bar are made of metal aluminum, and the fuse is made of metal copper.

Further, in the above-mentioned busbar, the connection line and the connection bar are made of metal copper, and the fuse is made of metal aluminum.

Compared with the prior art, the advantages of the techniques disclosed herein are:

It has a simple structure, and the connection line and the connection row are electrically connected by an independently set fuse. The processing of the fuse does not need to consider the material and thickness of the connection line and the connection row, which reduces the difficulty of the production process, improves the product yield, reduces material waste, and reduces production costs. Correspondingly, the material selection of the connection line and the connection row does not need to consider the need for processing the fuse; in addition, the independently set fuse can also be used on the busbar where the fuse cannot be set originally to protect the circuit, thereby improving the safety of use; at the same time, the independently set fuse can achieve a very low fusing current, which solves the technical problem that a low-current fusing fuse cannot be made due to material properties and thickness restrictions, that is, it solves the technical problem that the fusing current of the existing line fuse is not low enough.

### BRIEF DESCRIPTION OF THE FIGURES

In order to more clearly illustrate the technical solutions in the embodiments disclosed herein, the drawings are briefly introduced below. Obviously, the drawings described below are only some embodiments disclosed herein. For ordinary technicians in this field, other drawings can be obtained based on these drawings without creative work.

FIG. 1 shows a schematic diagram of the structure of the busbar in a specific embodiment.

FIG. 2 shows a schematic diagram of the structure of the busbar after omitting the insulating layer and the insulating film in a specific embodiment.

FIG. 3 shows a schematic diagram of the connection between the connecting line and the connecting bar in a specific embodiment.

FIG. 4 shows a schematic diagram of the welding of the fuse in a specific embodiment.

FIG. 5 shows a cross-sectional schematic diagram of the busbar in a specific embodiment.

### DESCRIPTION

The technical solutions in the embodiments disclosed herein are described in detail below in combination with the drawings. Obviously, the described embodiments are only some of the possible embodiments, and are not all of them. Based on the embodiments of the present invention, all other embodiments obtained by ordinary technicians in this field without creative work are within the scope of protection of the present invention. In the description of the present invention, it should be noted that the terms “center,” “upper,” “lower,” “left,” “right,” “vertical,” “horizontal,” “inside,” “outside” and the like indicate the orientation or position relationship based on the orientation or position relationship shown in the drawings, which is only for the convenience of describing the present invention and simplifying the description, and does not indicate or imply that the device or element referred to must have a specific orientation, be constructed and operated in a specific orientation, and therefore cannot be understood as a limitation on the present invention. In addition, the terms “first,” “second,” and “third” are only used for descriptive purposes and cannot be understood as indicating or implying relative importance. In this description, it should be noted that, unless otherwise clearly specified and limited, the terms “installation,” “connection” and “connecting” should be understood in a broad sense, for example, it can be a fixed connection, a detachable connection, or an integral connection; it can be a mechanical connection or an electrical connection; it can be a direct connection or an indirect connection through an intermediate medium, and it can be the internal connection of two components.

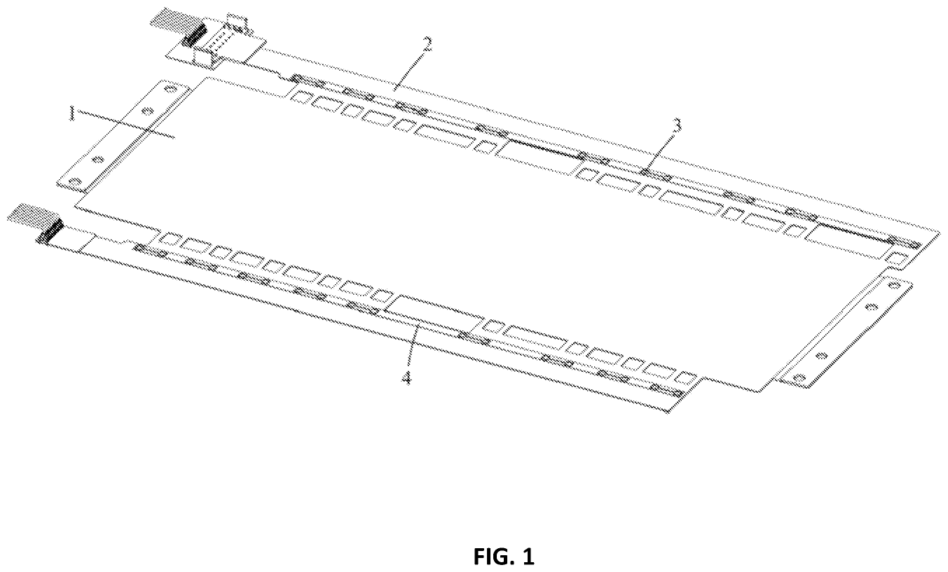

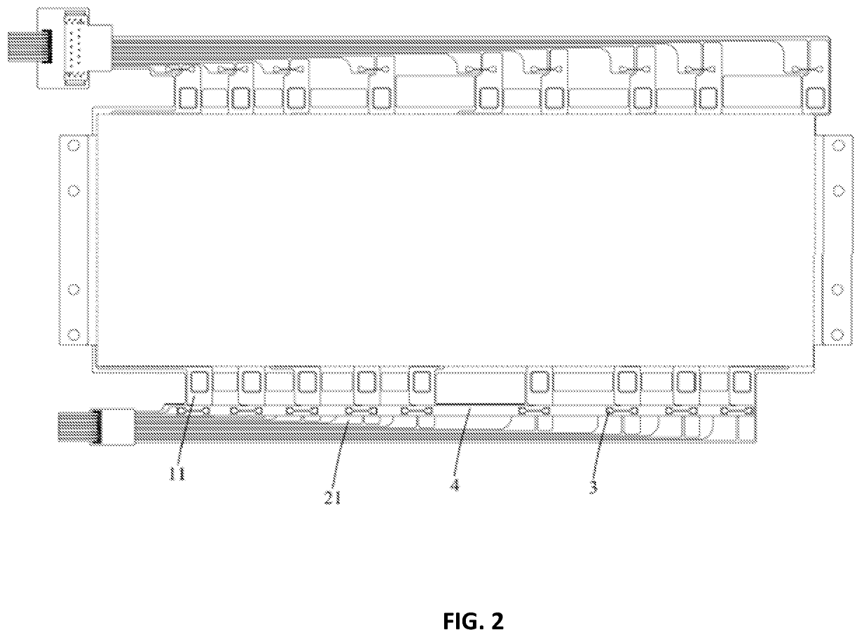

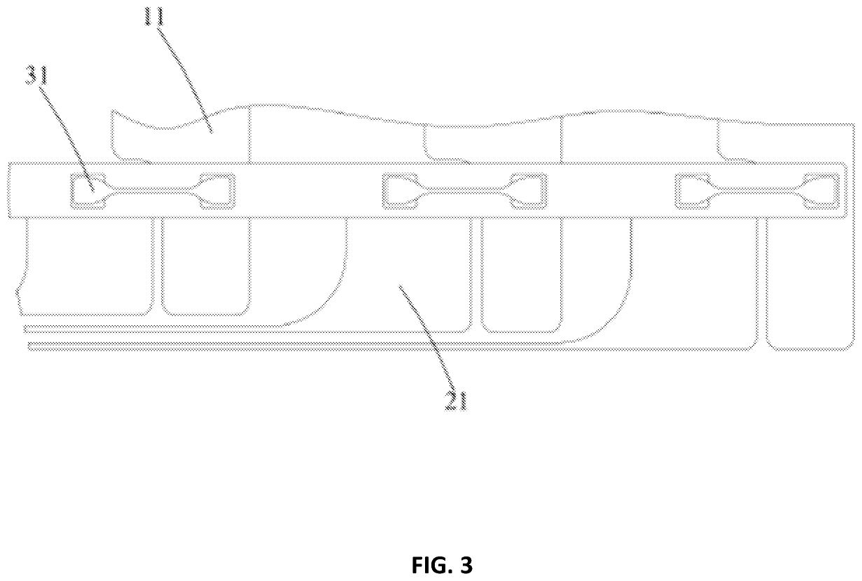

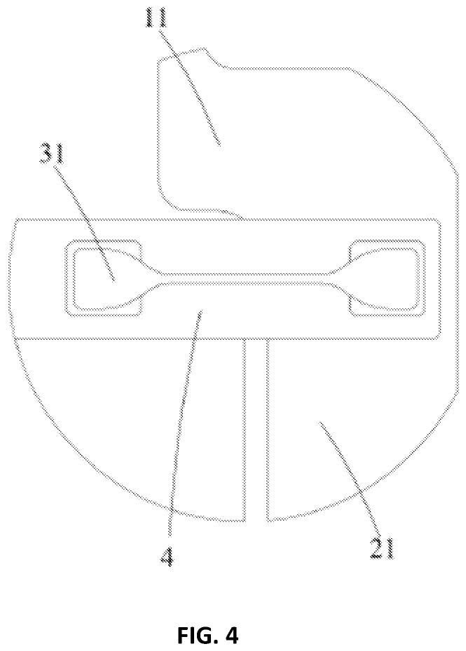

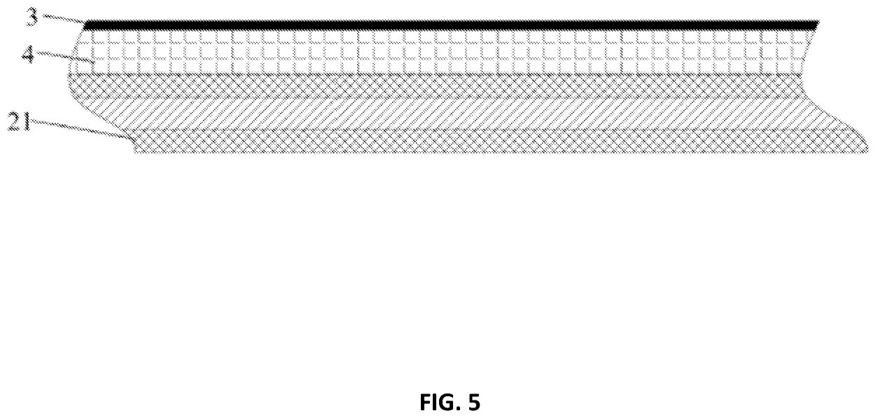

For ordinary technicians in this field, the specific meanings of the above terms herein can be understood according to specific circumstances. For example, referring to FIGS. 1 to 5, a busbar includes a busbar 1 for integrating battery cells and a VSH component electrically connected to the busbar 1. The busbar 1 is provided with a plurality of connection bars 11 connected to the positive or negative electrodes of the battery cells (not shown) and an insulating layer covering both sides of the connection bars 11. The VSH component includes a first circuit board 2. The first circuit board 2 includes a plurality of connection lines 21 and an insulating film covering both sides of the connection lines 21. The end of the connection bar 11 facing away from the battery cell is connected to the corresponding connection line 21 through a fuse 3. The fuse 3 is provided on the outside of the corresponding insulating film and insulating layer. The insulating film and insulating layer are respectively provided with a plurality of welding windows. The connection lines 21 and the connection bars 11 form pads at the corresponding welding windows, respectively. The two ends of the fuse 3 are respectively electrically connected to the corresponding pads. In this technical solution, the busbar is provided with a number of pole ears (not shown) electrically connected to the corresponding connection row, which is used to electrically connect the positive or negative electrode of the battery cell. The first circuit board 2 is a conventional flexible circuit board, and the connection row is connected to the BMS through a conventional printed circuit board (“PCB”) and a plug connector. A number of welding windows are opened in the insulating film and the insulating layer to expose the corresponding connection row and connection line, and form a welding pad. The two ends of the fuse are respectively welded to the corresponding welding pads to electrically connect the connection row and the connection line. When processing the fuse, there is no need to consider the material and thickness of the connection line and the connection row, which reduces the difficulty of the production process, improves the product yield, reduces material waste, and reduces production costs. Correspondingly, the material selection of the connection line and the connection row does not need to consider the need for processing the fusc. In addition, the unique independently set fuses can also be used on buses where fuses cannot be set originally. By opening welding windows on the corresponding insulating layer and insulating film and welding fuses, the circuit can be protected, thereby improving the safety of use; at the same time, the fuse can also be connected between two buses or battery packs and other products, so as to connect multiple products together and protect the circuit; at the same time, independently set fuses can achieve very low fusing currents, solving the technical problem that low-current fusing fuses cannot be made due to material properties and thickness limitations, that is, solving the technical problem that the fusing current of existing line fuses is not low enough. For example, as shown in FIGS. 1 to 5, a mica sheet 4 is set between the fuse 3 and the insulating film and insulating layer, and a avoidance groove corresponding to the welding window is set in the mica sheet 4. In this technical solution, the mica sheet is glued on the side close to the insulating film and insulating layer, and is directly attached to the insulating film and insulating layer.

The corresponding positions of the insulating film and the insulating layer can be used, and the avoidance groove and the welding window overlap to avoid interference with the welding between the fuse and the pad. The mica sheet 4 has good high temperature resistance and insulation performance. Even if the fuse 3 is overloaded and melted, it will not burn the connection row and the connection line. After troubleshooting, the corresponding fuse 3 can be replaced.

For example, as shown in FIGS. 1 to 4, the two ends of the fuse 3 are respectively protruded with welding terminals 31, and the welding terminals 31 are integrally formed with the fuse 3.

In this technical solution, the shape of the welding terminal is not required, and the contact area between the fuse and the pad is increased, and the welding strength between the fuse and the pad is improved.

For example, as shown in FIG. 1, the insulating layer and the insulating film on the same side are an integrated structure.

In this technical solution, the busbar and the first circuit board are arranged in the same flexible circuit board. After the connection bar and the connection line are made, a layer of polyethylene terephthalate (“PET”) film is attached to the upper and lower sides respectively, and hot-pressed as a whole. The welding window can be opened after being pre-set before attachment and hot-pressed. The insulating layer and insulating film on the same side of the connection bar and the connection line are a PET film. After hot-pressing, the relative position of the connection bar and the connection line is fixed to avoid breaking the fuse; to ensure the strength of the busbar, an insulating plate is arranged on the end face of the busbar away from the battery cell, and the insulating plate is fixed to the corresponding PET film by gluing or other means. For example, the insulating layer and the insulating film are split structures, that is, the busbar and the first circuit board are arranged separately. Before or after the fuse is welded, the busbar and the first circuit board are fixed to each other by means of tape or the like in combination with mica sheets to avoid the busbar and the first circuit board from shaking or shifting relative to each other and breaking the fuse. Exemplarily, the connection line 21, the connection bar 11 and the fuse 3 are made of the same conductive material, and the conductive material includes aluminum, copper and stainless steel. In this technical solution, the same materials can be directly fixed to each other by laser welding and other methods, which is convenient for processing. Exemplarily, the connection line 21, the connection bar 11 and the fuse 3 are all made of metal aluminum. In this technical solution, compared with the integrated fuse (the fuse is directly processed on the connection line and the connection bar), the connection line and the connection bar do not need to choose the high-cost copper to ensure the performance of the fuse, that is, the connection line and the connection bar are processed by aluminum plate by laser cutting and other processes, and are made into a flexible circuit board by conventional roll-to-roll process, the fuse is cut by aluminum foil and laser welded to the corresponding pad, the fuse is processed separately, and its length and thickness can be processed separately according to the rated current and are not limited by the connection line and the connection row; the resistance of the fuse R=μL/S, that is, the resistance of the fuse is proportional to its length L and resistivity ρ, and inversely proportional to its cross-sectional area S. The fuse width and thickness can be reduced to reduce its cross-sectional area, thereby shortening the length of the fuse. Without occupying a large space, the fuse can meet the requirements of low current fusing, solving the technical problem that the existing line cannot make a low current fusing fuse due to material properties and thickness limitations, that is, solving the technical problem that the fusing current of the existing line fuse is not low enough.

Exemplarily, the connection line 21, the connection bar 11 and the fuse 3 are all made of metal copper.

In this technical solution, the copper fuse can be directly welded to the copper connection line and the connection row by laser welding or other methods, which is convenient for processing, meets the needs of the busbar with requirements on the material of the connection line and the connection row, and can also be applied to the transformation of the existing copper busbar, etc.

Exemplarily, the connection line 21, the connection bar 11 and the fuse 3 are made of different conductive materials, and a transfer layer (not shown) is provided on the end face of the pad close to the fuse 3 or the side face of the end of the fuse 3 close to the pad. In this technical solution, the fuse can also be made of a conductive material different from the materials of the connection line and the connection row. The welding terminal cannot be directly welded to the corresponding pad. The welding is performed by adding a transfer layer between the welding terminal and the pad. The transfer layer is fixed on the welding terminal or the pad, or can be provided separately. The transfer layer is a single-layer structure or a multi-layer structure. For example, the transfer layer is a nickel-plated layer, which is used for welding a copper welding terminal to an aluminum pad or an aluminum welding terminal to a copper pad. For another example, the transfer layer is a nickel-plated aluminum sheet, which is pre-welded to a copper pad or a welding terminal, and connected to the corresponding aluminum welding terminal or pad by laser welding, so that melting welding between welding terminals and pads of different materials can be achieved. Exemplarily, the connection line 21 and the connection bar 11 are made of metal aluminum, and the fuse 3 is made of metal copper.

In this technical solution, the connection line and the connection bar are both made of metal aluminum to reduce material costs. When the installation space permits, a copper fuse is selected. Compared with metal aluminum, copper has higher mechanical strength and flexibility, which reduces the possibility of being torn off.

Exemplarily, the connection line 21 and the connection bar 11 are made of metal copper, and the fuse 3 is made of metal aluminum.

In this technical solution, the resistivity of metal aluminum is greater than the resistivity of metal copper. When the fuse cross-sectional area is the same, the length of the aluminum fuse is less than that of the copper fuse with the same resistance value, and the aluminum fuse is convenient for miniaturized design.

In summary, the aspects disclosed herein includes a simple structure, and the connection line and the connection row are electrically connected by an independently set fuse. The processing of the fuse does not need to consider the material and thickness of the connection line and the connection row, which reduces the difficulty of the production process, improves the yield rate of the product, reduces material waste, and reduces production costs. Correspondingly, the material selection of the connection line and the connection row does not need to consider the need for processing the fuse; in addition, the independently set fuse can also be used on the bus where the fuse cannot be set originally to protect the circuit, thereby improving the safety of use; at the same time, the independently set fuse can achieve a very low fusing current, which solves the technical problem that a low current fusing fuse cannot be made due to material properties and thickness restrictions, that is, it solves the technical problem that the fusing current of the existing line fuse is not low enough.

It should be noted that, in this article, the terms “include,” “comprises” or any other variants thereof are intended to cover non-exclusive inclusion, so that a process, method, article or device including a series of elements includes not only those elements, but also other elements not explicitly listed, or also includes elements inherent to such process, method, article or device. In the absence of further restrictions, the elements defined by the sentence “including a . . . ” do not exclude the existence of other identical elements in the process, method, article or device including the elements. The above is only a specific implementation of the disclosed techniques. It should be pointed out that for ordinary technicians in this technical field, several improvements and modifications can be made without departing from the principles herein, and these improvements and modifications should also be regarded as part of the scope of protection herein.

What is claimed is:

1. A busbar, comprising:
a busbar for integrating battery cells and a voltage sense harness (“VSH”) component electrically connected to the busbar, the busbar including a plurality of connection bars connected to positive or negative electrodes of the battery cells and an insulating layer covering both sides of the plurality of connection bars, the VSH component including a first circuit board with a plurality of connection lines and an insulating film covering both sides of the plurality of connection lines, one end of a connection bar located away from a battery cell being connected to a corresponding connection line through a fuse, the fuse being provided on the outside of the corresponding insulating film and insulating layer, each of the insulating film and insulating layer having welding windows, wherein the plurality of connection lines and the plurality of connection bars are respectively provided with welding pads at corresponding welding windows, and two ends of the fuse are respectively electrically connected to corresponding welding pads.

2. The busbar according to claim 1, further comprising:
a mica sheet is provided between the fuse and the insulating film and insulating layer, wherein an avoidance groove corresponding to a welding window is provided in the mica sheet.

3. The busbar according to claim 1, wherein welding terminals protrude at both ends of the fuse, and the welding terminals are integrally formed with the fuse.

4. The busbar according to claim 1, wherein the insulating layer and insulating film on the same side are an integrated structure.

5. The busbar according to claim 1, wherein each of the plurality of connecting lines, the plurality of connecting bars, and fuse is made of the same conductive material.

6. The busbar according to claim 5, wherein each of the plurality of connecting lines, the plurality of connecting bars, and fuse is made of metal aluminum.

7. The busbar according to claim 5, wherein each of the plurality of connecting lines, the plurality of connecting bars, and fuse is made of metal copper.

8. The busbar according to claim 1, wherein the plurality of connecting lines, the plurality of connecting bars, and the fuse are made of different conductive materials, and a transfer layer is provided on an end face of a soldering pad close to the fuse or on the side of the fuse end close to the soldering pad.

9. The busbar according to claim 8, wherein the plurality of connecting lines and the plurality of connecting bars are made of metal aluminum, and the fuse is made of metal copper.

10. The busbar according to claim 8, wherein the plurality of connecting lines and the plurality of connecting bars are made of metal copper, and the fuse is made of metal aluminum.
